(19) United States
(12) Patent Application Publication
(10) Pub. No.: US 2004/0117268 A1
(43) Pub. Date: Jun. 17, 2004

(54) Method, service and communication system for the food industry and the distribution industry

(76) Inventors: Michael W. Grogan, Chicago, IL (US); Chris Giannis, Chicago, IL (US)

Correspondence Address: MCANDREWS HELD & MALLOY, LTD, 500 WEST MADISON STREET, SUITE 3400, CHICAGO, IL, 60661

(21) Appl. No.: 10/458,577

(22) Filed: Jun. 9, 2003

Related U.S. Application Data
(60) Provisional application No. 60/434,190, filed on Dec. 16, 2002.

(51) Int. Cl. G06F 17/60

(52) U.S. Cl. 705/26

(57) ABSTRACT

An on-line communication service, system and method adapted to used to provide an internet platform for business services/products solutions used in a distribution industry. One embodiment of the system adapted to be used in a distribution industry comprises a sales person module and at least one of a warehouse module and a delivery module. The system further comprises at least one end-user module adapted to communicate with at least one of the sales person, warehouse and delivery modules.

### CROSS-REFERENCE TO RELATED APPLICATIONS

This application is related to, and claims benefit of and priority from, Provisional Application No. 60/434,190 dated Dec. 16, 2002, titled “Method, Service and Communication System for the Food Industry and The Distribution Industry”, the complete subject matter of which is incorporated herein by reference in its entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Aspects of the present invention relate to a method, service and communication system. More specifically, the present invention relates to a method, service and communication system for the distribution industry, the food industry for example.

Known ordering processes are generally manual, paper driven processes that provide a number of opportunities for error. The grocer orders from the sales person, who orders from the warehouse, who sends items to the dock for delivery to the grocer. Orders may be missed or delayed, wrong items ordered, to many or to few items ordered or shipped, invoices incorrectly prepared and sent, etc. One embodiment of the present invention provides an internet online based method, system and service for use by the distribution industry, that reduces or eliminates such errors.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention relate to a method, service and communication system. More specifically, the present invention relates to a method, service and communication system for the distribution industry, including at least the food industry.

One embodiment of the present invention relates to an on-line communication system adapted to be used in a distribution industry. In this embodiment, the system comprises of a sales module and at least one of a warehouse module and a delivery module. The system further comprises at least one end-user module adapted to communicate with at least one of the sales, warehouse and delivery modules.

Another embodiment of the present invention relates to an on-line communication system adapted to be used in a delivery industry. In this embodiment, the system comprises a hub, a sales module, and at least one of a warehouse module, a delivery module and a corporate module communicating with at least the hub. At least one end-user module is adapted to communicate with the hub and at least one of the sales module, warehouse module and delivery module.

Still another embodiment of the present invention relates to an ordering method used in a distribution industry. This embodiment comprises communicating with at least one sales person responsible for at least one distribution warehouse using a communication system and communicating an order confirmation to the sales person using the communicating system.

Yet another embodiment of the present invention relates to an ordering method used in a distribution industry. This embodiment comprises placing at least one order using a communication system and communicating an order confirmation using the communicating system. The invention further comprises generating a sales order using the communication system.

One other embodiment of the present invention relates to an on-line ordering service. This embodiment comprises provider on-line ordering and confirmation of the online ordering. The service further provides at least one of bookkeeping and report generating with respect to at least the on-line ordering.

These and other advantages, aspects and novel features of the present invention, as well as details of an illustrated embodiment thereof, will be more fully understood from the following description and drawings.

### DESCRIPTION OF SEVERAL VIEWS OF THE DRAWINGS

For a more complete understanding of the present invention and the advantages thereof, reference should be made to the following Detailed Description taken in connection with the accompanying drawings in which:

FIG. 1 illustrates an example of one known ordering process;

FIG. 2 illustrates a high level overview of the method, service and communication system in accordance with one embodiment of the present invention;

FIG. 3 illustrates one embodiment of a salesman module in accordance with the present invention;

FIG. 4 illustrates one embodiment of a bookkeeping module in accordance with the present invention;

FIG. 5 illustrates one embodiment of a report generator in accordance with the present invention;

FIG. 6 illustrates one embodiment of a wireless module in accordance with the present invention;

FIG. 7 illustrates one embodiment of a salesman online ordering module in accordance with the present invention;

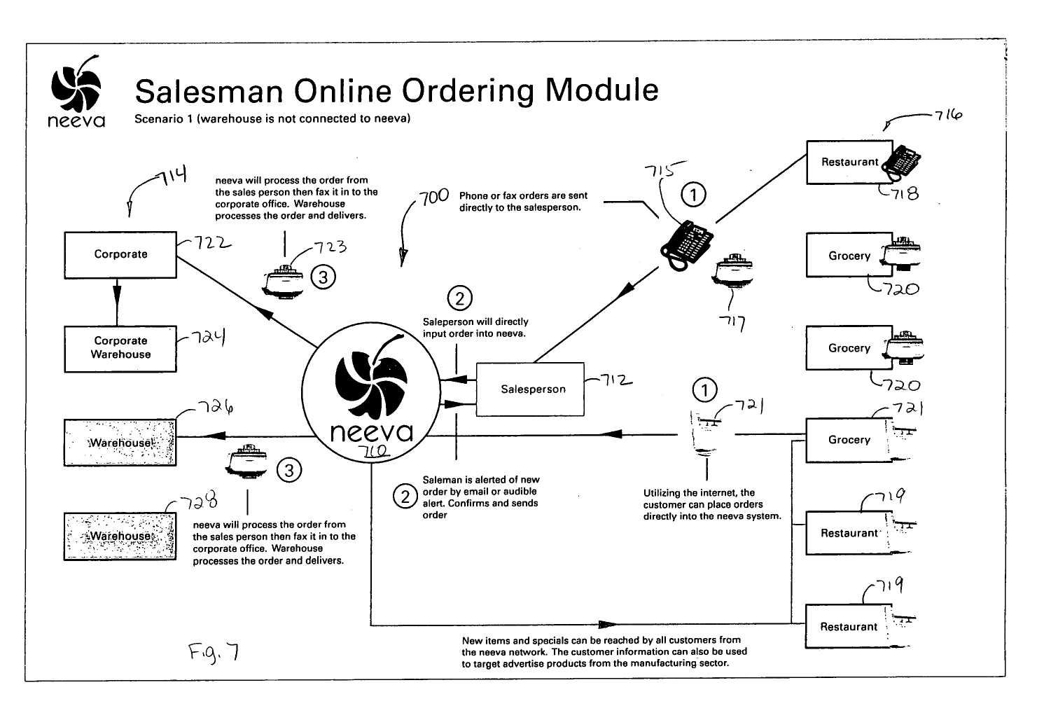

FIG. 8 illustrates one embodiment of a warehouse module in accordance with the present invention; and

FIG. 9 illustrates one embodiment of an end user module in accordance with the present invention.

### DETAILED DESCRIPTION OF THE INVENTION

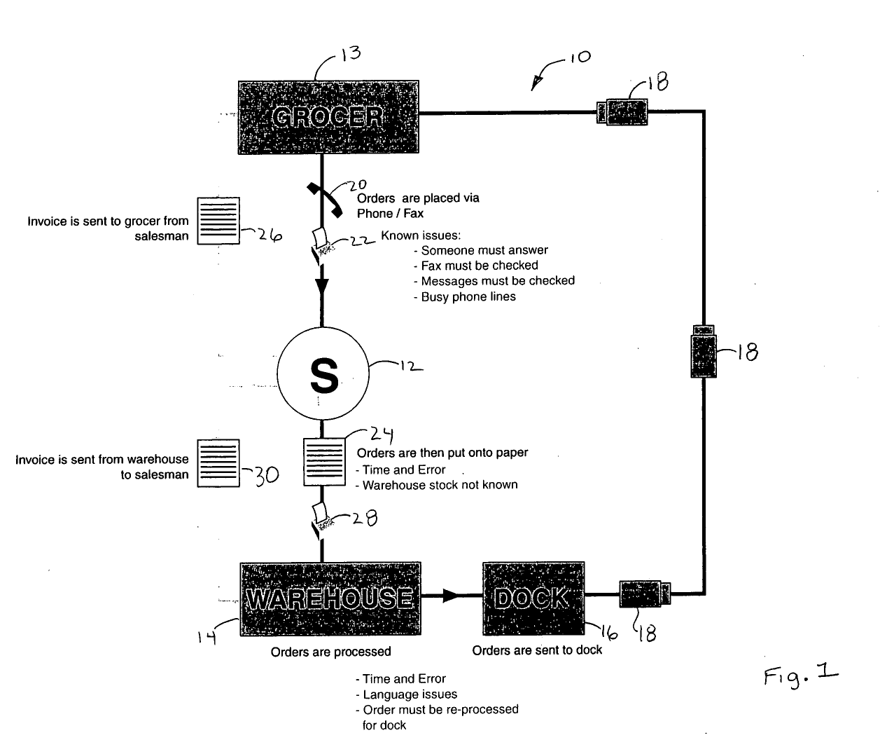

Turning to FIG. 1, an example of one known ordering process, generally designated 10, is illustrated. In this illustrated example, the system 10 comprises one or more sales people 12, one or more grocers 13, one or more warehouses 14 having one or more docks 16 to accommodate one or more trucks 18.

As illustrated, the grocer 13 places an order with the sales person 12 using a phone 20 and/or fax 22. It is contemplated that to fill this order, the order must be received and checked before the order is placed with the warehouse 14. However, it is known that the phone/fax lines may be busy, voice mail full, the fax machine out of paper, etc., causing the order to be delayed or missed. In fact, if the orders are missed or delayed often enough, the grocer 13 may find a new sales person.

After the order is received by the sales person, it is put on paper 24 (i.e., a completed order), a manual process that requires time and provides an opportunity for order error. For example, the sales person 12 may order the wrong item, use the wrong SKU #, not order enough items, order to many items, etc. Further, it should be appreciated that the sales person 12 does not know if the ordered items are currently in stock at the time they prepare the order. The completed order 24 is transmitted to the warehouse 14, via fax 28 for example.

In this example, the warehouse 14 receives and processes the order. This includes pulling any items and processing them for delivery to the dock 16. Again, it is contemplated that manually filling this order provides an opportunity for error. Language/writing issues could arise, so that the wrong items or amounts are pulled. In this example, the warehouse 14 prepares an invoice 30, which is transmitted to the sales person 12. The sales person 12 prepares his own invoice 26, or reuses the warehouse invoice 30, which is sent to the grocer 13, via fax or mail for example. The pulled items are sent to the dock 16 for delivery to the grocer 13 via one or more trucks 18 (or other delivery methods) for example.

One embodiment of the present invention relates to the food distribution industry, although other embodiments may relate to other distribution based businesses and industries. It is contemplated that the present invention may provide solutions to problems encountered by various distribution businesses and industries, but may also provide service data gathering and become a repository of information for any industry that uses the present invention's products and services.

Aspects of the present invention relate to a method, service and communication system. More specifically, the present invention relates to a method, service and communication system for the distribution industry, including at least the food industry. Even more specifically, embodiments of the present invention relate to a highly functional online subscription service for various distribution industries such as the food distribution industry. Embodiments of the present invention enable all parties (i.e., the end-user for example) communicating with the system to communicate directly with the sales person responsible for the respective warehouse, enabling order confirmations to be communicated back from the warehouse to the sales person and end-user with order tracking information. The present invention is a web based (i.e. internet) system that works with minimal software installation for any subscriber to the service.

In one embodiment of the present invention, accounting applications are integrated with or replace existing accounting applications used by all parties to the system. Examples of such software applications include but, are not limited to, Accounts Receivable, Accounts Payable, Inventory Control, Payroll, Taxes, and Cost Accounting, etc.

It is contemplated that data will be stored and multiple levels of redundant back-up will be provided. One or more warehouses communicating with the system may be separated by “firewalls of security” to segregate sensitive information. Examples of such sensitive information includes, but is not limited to, SKU #s, pricing, descriptions, delivery schedules, accounting applications, order tracking, etc.

It is further contemplated that Web based advertising may be included in one or more embodiments of the present invention. Using a main web site or linking a second web site, warehouses/distributors may have immediate access to their end-user customer base. This method of advertising may be extended to any company that targets the distribution industry.

It should be appreciated that a sales person that represents one or more warehouses will only see the warehouse pricing for those warehouses that are subscribers to the system. Additionally, warehouses may not see competitor warehouses pricing. This segregation ensures that sales people/warehouses do not under-cut one or the other. Special pricing may be offered to a customer direct via the warehouse through the sales person. Any warehouse/distributor may “broadcast” a special via the advertising link.

It is contemplated that the system may become a resource for the distribution industry, possessing massive amounts of data. With respect to the food industry for example, one or more of the following services may be provided: space for direct and targeting advertising; a directory of companies (for example, a caterer may access information to find vendors for their events) and means to provide relevant information to all subscribers (for example FDA Reports, Health issues, etc.).

It is contemplated that at least one or more services may be provided online. Not only may data be provided online, but one or more software applications may be accessed online as well. This means that subscribers have no need to purchase expensive software packages that are not specifically designed for them. There are many accounting packages in the market, but they are generic and do not address the issues of any particular industry. The system will provide the subscribers with applications that are designed for their needs.

It is also contemplated that the present invention may, in one embodiment, provide immediate software updates and customized solutions. As information is provided online, any changes may be immediately and instantaneously updated at the subscribers end. In fact it is contemplated that the subscriber does not have to reinstall any applications on their terminal. For example, if a form must be changed or updated, the changes are made on the server. Once the form is implemented the subscriber see the changes on their screen (in real time for example). This process may assist major corporations, saving these corporations massive amounts of time due to reinstalling software updates.

One or more of the modules systems will be adapted to communicate with one or more of the modules, using standard software or communication conventions, eliminating data re-entry. At least one embodiment of the present invention will be adapted able to communicate using standard software conventions. From database structures to accounting procedures, one or more modules in the system will communicate using such procedures or applications, eliminating data re-entry for each module.

It should be appreciated that the system will be most powerful when subscribers use the system exclusively. There will be no need to the subscriber to re-enter data once it is stored. If the subscriber uses only one of the system's modules, it does not matter that they do not subscribed to the others. This means that data that is inputted from one module and is available to at least one by generally all other modules. When the subscriber chooses another module, that module will be able to access all relevant data stored on the system's without the user having to enter redundant data.

The following describes at least one embodiment of the present invention comprising at least one or more modules (software modules for example) adapted to provide an internet platform for business services/products solutions as well as a communication network for the distribution industry (the food industry for example). It is contemplated that the present invention may provide customized business solutions through design and implementation. At the same time the present invention may provide affordable service via the internet through an independent hosting system that is accurate and dependable for distribution companies, including but not limited to the food, beverage, apparel, confectionary, cigar/cigarettes industries, etc.

In one embodiment, the present invention's income markets may include: corporate headquarters, producer/supplier, warehouse/distributor, related sales people, and end point retailers. It is contemplated that embodiments of this invention may have world wide applications for all products that require at least a warehouse to retailer relationship.

One embodiment of the present invention relates to an internet online based system, service and method for use by the distribution industry. In this embodiment, the system comprises at least one end-user module communicating with at least one of a sales module, a warehouse module and a trucker module, using a hub for example. Further in this embodiment, the system is the hub for all data, used as a resource site for the industry. It is contemplated that the users may be provided with online immediate software updates and customized solutions. It is further contemplated that one or more modules will be able to communicate with at least one other module, eliminating data re-entry.

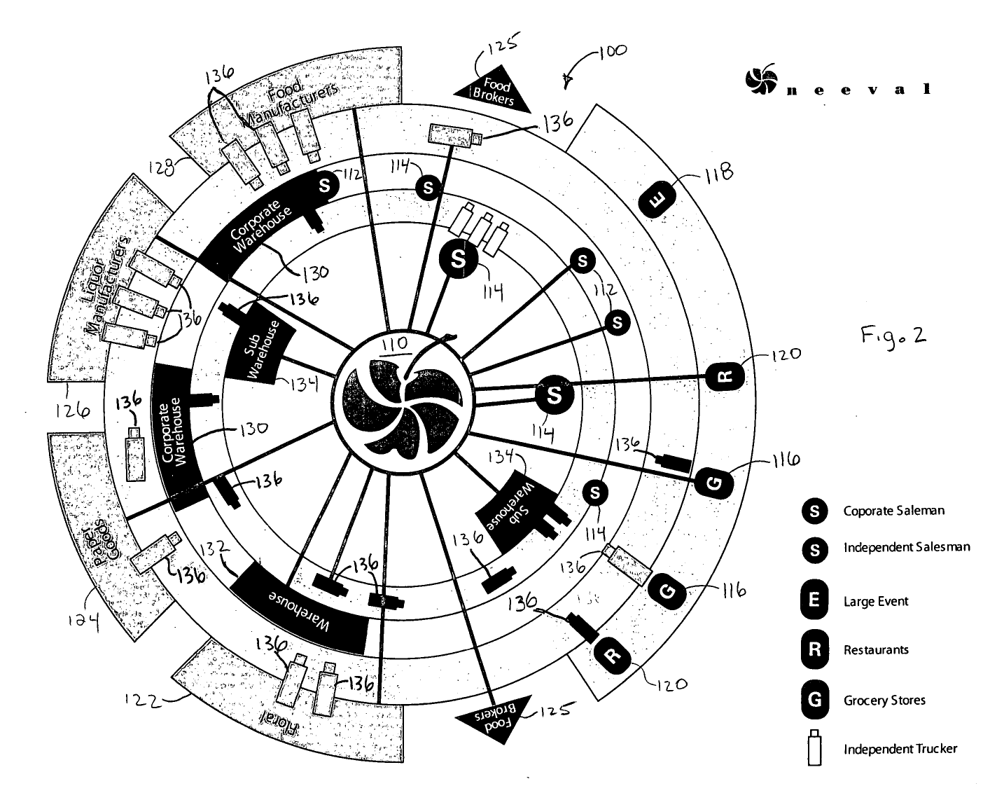

FIG. 2 illustrates a high level overview of the method, service and system in accordance with one embodiment of the present invention. In this illustrated embodiment, the system 100 comprises hub 110; one or more sales people, here comprising corporate sales people 112 and independent sales people 114 for example; one or more end users or retailers, here comprising grocery stores 116, large events 118 and restaurants 120 for example; one or more producers/providers here comprising floral shops 122, paper good producers/providers 124, liquor manufactures 126, food manufacturers 128 and one or more food brokers 125 for example; one or more warehouses here comprising corporate warehouses 130, independent warehouses 132, sub warehouses 134 (each having one or more docks) for example; and trucks or other delivery vehicles 136 (where the trucks may comprise, for example, one or more of the producers/provider trucks, corporate warehouse trucks, sub warehouse trucks or independent trucks). In this embodiment, at least one or more of the sales people, end users, producers/providers, warehouses and trucks communicate with the hub 110. While it is contemplated that one embodiment of the present invention may include all the elements as described above, it is also contemplated that embodiments of the present invention may include only some or a different combination of the elements illustrated in FIG. 2. Furthermore, it is contemplated that embodiments of the present invention include elements not depicted in FIG. 2.

It is contemplated that, in at least one embodiment, all of the products and services may be available to be used online. There is no software to purchase from a physical store. Products may be downloaded to the subscribers via the internet, and services executed online. For example, any calculations, transactions, or processing may be done online from a hub, similar to hub 110 of FIG. 2, where the hub comprises one or more servers. The executed data may then be sent to the subscribers online (via the internet for example). Data may be displayed using any interface (video monitor, display, computer, PDA, phone, printer, etc.).

In at least one embodiment, the data is stored on at least the hub 110 (on at least one server at the hub 110) and the subscriber's or end user's terminal. This provides for data integrity and backups for the subscriber. In the case of a system crash on the subscriber's side, information may be restored from the hub (in one embodiment, in real time).

It is contemplated that the system 100 will have triple redundant backup systems. In other words, the database, as well as any application software program may be simultaneously running on at least a three tier backup system. It is further contemplated that a remote location may provide mirror services in order to retain data in case of a disaster at the original server location or hub.

It should be appreciated that, as the system 100 is an online service, subscribers may access the services from a plurality of location (any location that provides an internet connection for example via wire or fiber cabling, fiber optic cables, etc.). It should also be appreciated that wireless technology may also play a part. One embodiment of the present invention may provide wireless formatted data, enabling one or more subscribers to access information using any type of wireless communication device.

FIG. 2 illustrates the hub 110 may act as the central location and processing center for data on the system 100. As provided previously, storing the data on at least the hub servers benefits the subscribers. However, the present invention does more then store information. For example, in one embodiment of the present invention, information is shared with parties of common interest without compromising integrity between competing entities (i.e., competing warehouses/distributors). The present invention is adapted to deliver critical data to all common parties on a 24 hour, 7 day per week, and 365 day per year basis. For example, data may be retrieved automatically by the hub servers anytime data is entered or processed by the server from the subscriber. It is contemplated that this data may be in a raw state, but the hub processes such data, sending only relevant data to the various systems or modules. Ultimately the services to which the subscriber or end user is connected to determine what kind of information they will receive. In one embodiment of the present invention, the system 100 comprises one or more modules or systems including at least a sales module, a warehouse module, a corporate module, an end-user module, a trucker module and a world wide advertising module.

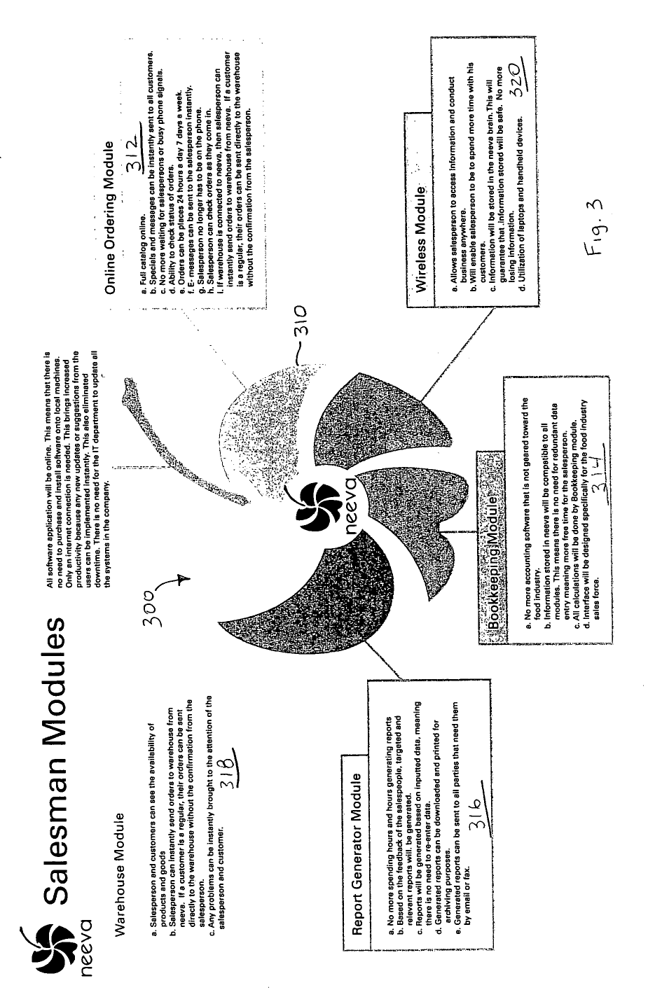

FIG. 3 illustrates one embodiment of the sales person or salesman module, generally designated 300. Applications, solutions and relevant data are provided to the sales person through the system. In the illustrated embodiment, the sales person or salesman module 300 comprises at least one of an online ordering module 312, a bookkeeping module 314, a report generator module 316, a warehouse module 318, and a wireless module 320, one or more of which are a part of, or communicate with, at least the hub 310 of the system. While only these modules or subsystems are illustrated and discussed, other modules (for example, a sales representative and marketing module; a promotions module, a customer and route surveys module, inventory information module, an accounting module, an instant emergency messaging module, etc.) are contemplated.

FIG. 3 illustrates at least one online ordering module 312 that is part of or communicates with the hub 310 the system. Currently orders in the food industry are placed using a fax or phone. In this embodiment, the online ordering module 312 enable the sales person's customers to access products online and order their products using the internet for example. This module holds or stores product information such as SKU #s, descriptions, price, etc. It is further contemplated that the module has multi-lingual abilities and conversions. Order information, as well as the customer information, is stored on the system for further processing.

It is contemplated that the online ordering module 312 may alleviate one or more problems associated with current order processes. Currently, orders are placed via fax or phone. Many orders take a long time to complete due to a number of orders coming in at once using a limited number of phone lines. However, in one embodiment of the present invention, the system is online. Therefore there is conceivably no limit to how many customers may access the system and the information at one time.

It is further contemplated that currently communicating with customers is difficult. In those situations where there is a need to send information out to a number of customers, known methods require reaching each customer separately. The present invention is adapted to provide information to a plurality of customers much faster then making individual phone calls or sending individual faxes. Using the present invention, the sales person may send a mass fax or email to one, two, more or all his or her customers. Furthermore it is contemplated that messages may be sent to customers via an access page. In one embodiment of the online ordering module 312, each sales person has an personal web site, enabling them to place or post messages or specials right on their homepage. This enables these sales people to reach a plurality of customers at one time.

One embodiment of the online ordering module 312 further enables sales people to eliminate some, if not all, of the endless amounts of paper currently required to place orders. Using the online ordering module 312, sales people no longer record all orders on paper. When the customer places an order online, the system automatically generates an order (in real time in one embodiment). The sales person may print that order out for his own records. The subscriber (i.e., the customer or end user) may access their order information online and view their order history. The subscriber may also print out any invoices, using that information for tax or inventory purposes.

In addition to online ordering, in one embodiment the online ordering module 312 is adapted to accommodate multiple ordering methods: phone orders, fax orders and internet orders for example. If the customer is not comfortable placing orders online, they can call the sales person directly. However, instead of writing down the order, the sales person accesses the order page on the system and types the order in himself. This places the order into the system, where the data is available for use later. If the customer decides to fax the order in, the system is adapted to receive such fax orders saving them as an image on the hub. This enables the sales person to access the fax from anywhere anytime. The sales person may choose to print the fax order, or keep it on the system. This arrangement provides for added security and data integrity. Since the fax is stored in digital form, it is not exposed to fire or other damaging circumstances. Once the fax is received, the system notifies the sales person that an order is in the queue (in real time in one embodiment). At that point the sales person may retrieve the fax and place the order just as if it was called in. The online ordering module is also adapted to accept internet orders. Internet orders may be automatically processed by the system. As provided previously with the fax ordering method, the system will notify the sales person of new order, enabling him to confirm the order. The system does the rest.

In the case of multiple warehouses, the online ordering module 312 enables the sales person to provide the necessary information about the stock-keeping system of each warehouse. In one embodiment, the system may be programmed to handle each warehouse separately. In this embodiment, the system acts as a filter, formatting the orders for each warehouse system. This arrangement saves the sales person time, as he doesn't need to worry about getting the item and SKU # correct for each of the warehouses. Once this data is input to the system, it processes the correct numbers of each warehouse. In this embodiment, the online ordering module 312 provides a full catalog online, enabling sending specials and messages to all customers simultaneously, enabling the subscribers to place, and check the status of, orders 24 hours a day, 7 days a week. This module eliminates waiting for sales people or busy phone signals. The sales person can check on orders as they come in. If the warehouse is coupled to or communicating with the system, the sales person may instantly send orders to the warehouse. Furthermore, if the customer is a regular, their orders may be sent directly to the warehouse without the sales person confirming the order.

FIG. 3 also illustrates at least one bookkeeping module 314 that is part of the system communicating with the hub 310. It is contemplated that this module may be an important tool of the sales people. Currently, many sales people use off the shelf applications to fulfill their bookkeeping needs. Other sales people have even created their own spreadsheet files to handle their bookkeeping needs. These applications are generally very generic and do not provide for customization or allow changes to be made in the process.

One embodiment of the present invention comprises a bookkeeping shell or module 314 that may be custom designed or adapted for each industry. In this embodiment, the bookkeeping module 314 provides only relevant information that each particular industry needs. Furthermore, as the module is provided online, the bookkeeping module 314 may be constantly updated (in real time for example) allowing for changing technology and needs.

It is contemplated that one embodiment of the bookkeeping module 314 accesses information stored in the system, by communicating with the hub 310 for example. Any order is entered using the online ordering module 312 for example is adapted to be processed by the bookkeeping module 314. Invoices, outstanding bills, inventory information, etc. may be provided by the bookkeeping module. Furthermore, just as in off the shelf accounting applications, checks may be printed and distributed using the bookkeeping module 314. Data may be stored on the system, eliminating data lost due to computer crashes. Furthermore, calculations and data processing may be performed on the system by the hub 310.

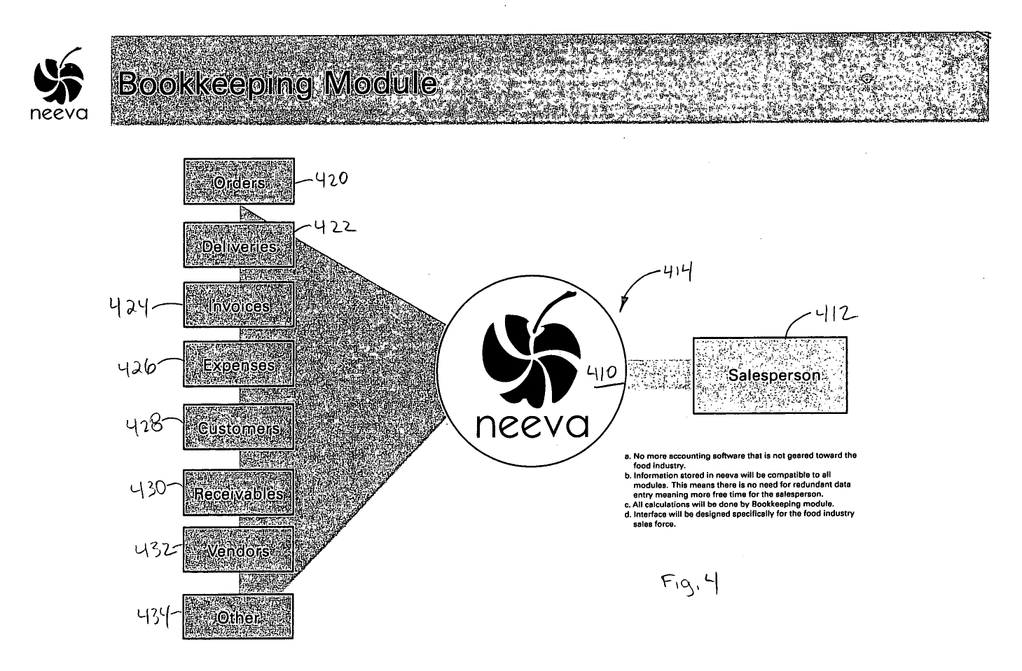

FIG. 4 illustrates one embodiment of the bookkeeping shell or module 414, similar to the bookkeeping module provided previously. Again it is contemplated that the bookkeeping module 414 provides only relevant information that each particular industry needs. Furthermore one or more interfaces may be designed for each particular industry, the food industry for example. In this embodiment, the bookkeeping module 414 accesses information stored in the system, by communicating with the hub 410 for example. Orders 420 are entered (by the sales person 412 for example) using the online ordering module for example and are adapted to be processed by the bookkeeping module 414. Deliveries 422, invoices 424, expenses 426, customers 428, receivables 430, vendor information 432 and other information 434 may be entered into the system and processed using the bookkeeping module 414. Using at least one embodiment of the bookkeeping module 414 eliminates using accounting software that is not geared to the distribution industry. It is contemplated that information or data stored on the system is compatible with at least one but generally all other modules on the system. This may eliminate redundant data entry, resulting in more free time for the users (the sales people for example). Further, all calculations may be performed by the bookkeeping module.

It should be appreciated that sales people have to generate daily, weekly and monthly reports. Currently, in order to fulfill these report requirements, the sales people take down information on paper, then transfer the data stored on paper to the computer to generate any needed reports. Not only do these sales people have to re-enter data, they generally use make-shift, off-the-shelf applications to generate the reports. Many hours are required, and even weekends may be lost, using the current method.

One embodiment of the present invention comprises at least one report generator module 316 as illustrated in FIG. 3. Just as in at least one other module as provided above, this module 316 may be accessed online. Sales people do not have to re-enter data to generate reports, rather reports may be generated using existing orders and data. Thus, the report generator module 316 uses data existing or stored on the system, automatically processing information for reports (in real time in one embodiment). This saves the sales people valuable time, enabling them to devote more time to their customers' needs. In one embodiment, it is contemplated that the report generator module 316 may send these reports to one or more parties communicating with the system and have need for such reports. For example, if the sales person works for a corporation, these reports may automatically be processed and sent to the corporate offices (via e-mail or fax for example) using one embodiment of the present invention.

It is contemplated that the report generator module 316 provides for data accuracy. As there is no need to transfer data from paper to a computer, the human error element is reduce or eliminated. As the chance of error due to transition is reduced, report errors are reduced, helping both the sales people and the corporate office to strategize better sales methods.

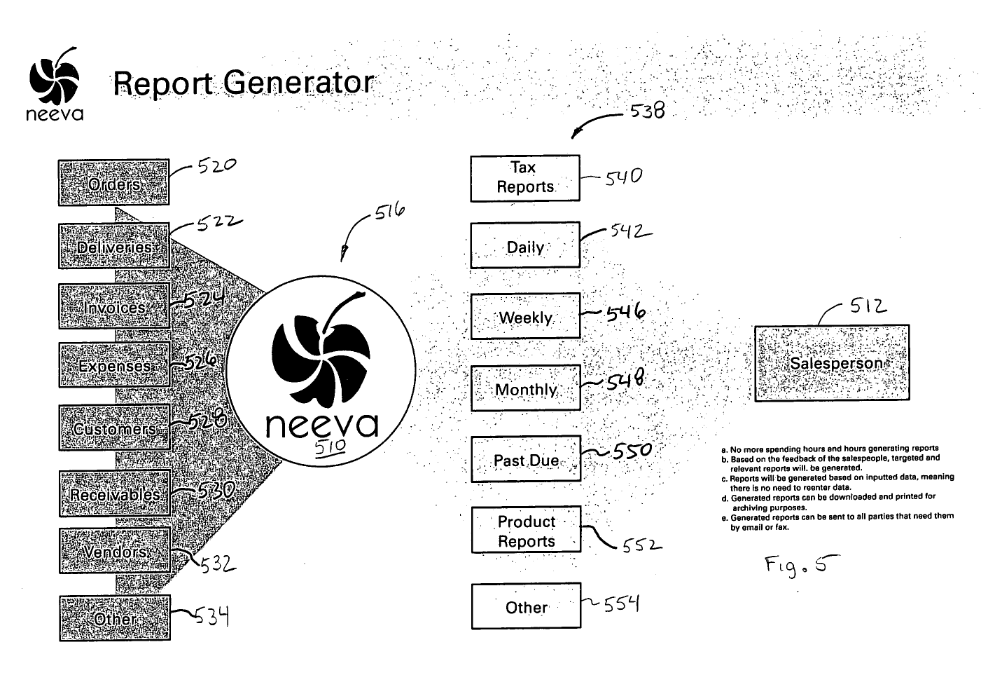

FIG. 5 illustrates one embodiment of a report generator module 516, similar to the report generator module provided previously. It should be appreciated that sales people 512 have to generate reports 538 such as daily reports 542, weekly reports 546, monthly reports 548, past due reports 550, product reports 552 and other reports 554. Just as in at least one other module as provided previously, this module 516 may be accessed online. In this embodiment, the module 516 accesses information stored on the system, by communicating with hub 510 for example. Orders 520 are entered (by the sales person 512 for example) using the online ordering module for example and are adapted to be processed by this module 516. Deliveries 522, invoices 524, expenses 526, customers 528, receivables 530, vendor information 532 and other information 534 may be processed using at least one embodiment of this module. Using at least one embodiment of the bookkeeping module eliminates using accounting software that is not geared to the distribution industry. It is contemplated that information or data stored on the system is compatible with at least one but generally all other modules on the system. This eliminates the need for redundant data entry, reducing the time spent generating reports. Generated reports may be downloaded and printed for archiving purposes and/or sent to one or more parties via e-mail or fax for example.

One embodiment of the present invention comprises a wireless module 320, which may be part of the sales person's module 300 (or one or more other modules) as illustrated in FIG. 3. In this embodiment, at least some of the data may be compatible with one or more wireless and mobile formats. It is contemplated that the data is adapted to be transferred via any wireless medium, used with handheld devices, PCs, phones, etc. that offer web service.

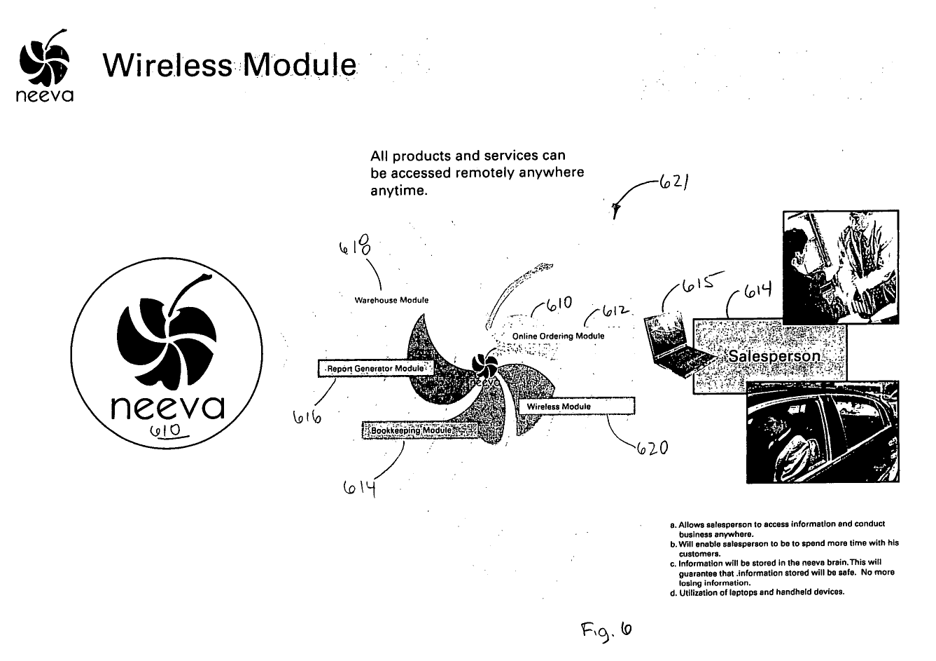

FIG. 6 illustrates one embodiment of a wireless module 621, similar to the wireless modules provided previously. In those instances where the sales person 614 uses a laptop 615 (or other wireless device), the sales person would be able to access at least the hub 610 of the system using an internet browser via any connective media (i.e., wire or wireless media for example). This enables the sales people to access at least one of the modules including the online ordering module 612, the bookkeeping 614, the report generator module 616, the warehouse module 618 and one or more other wireless modules. This enables sales people to be mobile and conduct business anywhere. The sales people 614 would be able to close orders right from their laptop 615 at the customer's location. This empowers the sales people to have more face to face dealings with their customers. Further, information input by the sales people is stored on the system (the hub for example). System redundancy reduces the chance of losing data as provided previously.

FIG. 6 illustrates one embodiment of a module generally designated 700 in accordance with one embodiment of the present invention. In this embodiment the one or more warehouses are not connected to the system. It is contemplated that one or more customers 716 (comprising restaurants 718 and grocers 720) may communicate with the sales people 712 using phones 715 and/or faxes 717 for example. The sales person 712 inputs these orders directly into the system (into the hub 710 for example). As illustrated, the system processes the order, transmitting it to the supplier 714 (comprising the corporate office 722) via fax for example. The corporate warehouse 722 (or other warehouses) process the received order and delivers it to the appropriate customer 716.

It is also contemplated that the customers 716 may communicate directly with the system. The customers 716 (comprising restaurants 719 and grocers 721) communicate directly with the system using one or more computers 721 or laptops and the internet. As illustrated, the system processes the order, transmitting it to the supplier 714 (here comprising warehouse 726 and 728, the corporate office 722 and the corporate warehouse 724) via fax for example. The corporate office processes the received order, transmitting it to the warehouse for delivery to the appropriate customer 716. It should be appreciated that in this scenario, the system alerts the sales person 712 (i.e., sends a confirmation for transmission) of the order via email or audible alert. It is further contemplated that the system enables one or more customers 716 reach new items and specials offered by the suppliers 714. The suppliers 714 may also use customer information to target advertise products from the manufacturing sector.

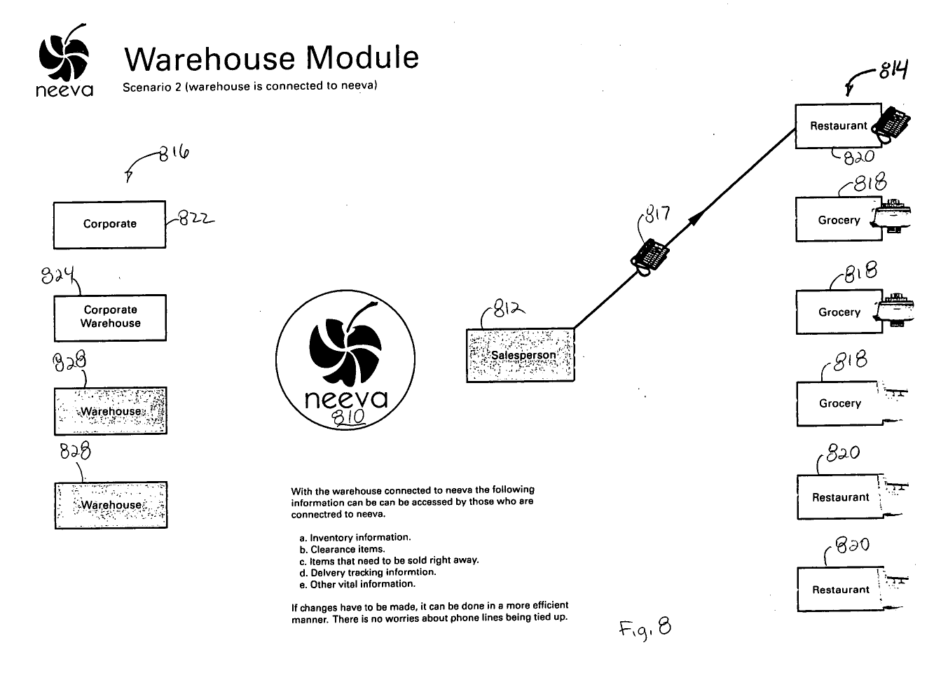

FIG. 8 illustrates one embodiment of a module, generally designated 800, in accordance with the present invention. In this embodiment, the one or more warehouses are connected to the system. It is contemplated that the customers 816 (comprising restaurants 818 and grocers 820) may communicate with the sales people 812 via phones 817 or faxes for example. The sales person 812 inputs these orders directly into the system (into the hub 810 for example). As illustrated, the system processes the order, transmitting it to the supplier 816 (comprising the corporate office 822, corporate warehouse 822 or one or more warehouses 828). The suppliers 816 processes the received order and deliver it to the appropriate customer 814. Connecting the warehouses to the system enables users to access inventory information, clearance items, items that need to be sold right away, delivery tracking and other vital information (in real time in one embodiment). Any changes may be made through the system in an efficient manner.

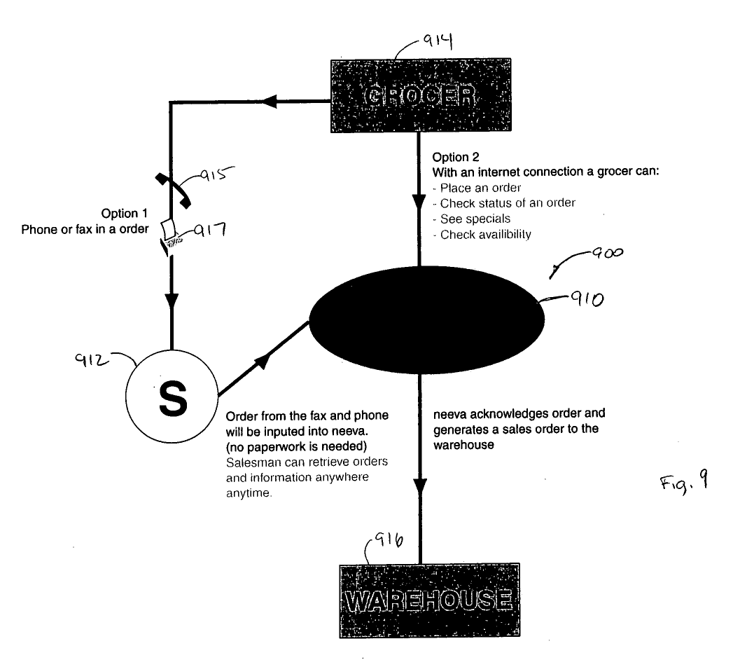

FIG. 9 illustrates one embodiment of a module, generally designated 900, in accordance with the present invention. In this embodiment, it is contemplated that the customer 916 (a grocer for example) has at least two options for placing an order. The customer may communicate the order to the sales people 912 using a phone 915 and/or fax 917 for example. The sales person 912 inputs these orders directly in the system. This eliminates paperwork and enables the sales people 912 to retrieve information anywhere at any time. Alternatively, the customer may place the order directly into the system. This enables the customer to check the status of an order, see specials and check the availability of a product. The system processes the order. Processing the order may include acknowledging the order (i.e., confirmation) and generating a sales order to the warehouse 916. The warehouse 916 processes the received order and delivers it to the appropriate customer 916. Enabling the warehouse 916 to be connected to the system enables users to access inventory information, clearance items, items that need to be sold right away, delivery tracking and other vital information. Any changes may be made through the system in an efficient manner.

It is contemplated that the illustrated module is adapted to help end users better communicate (with the sales people for example) when placing orders. This module may reduce stress, improve time management, provide affordable and dependable service customized to the end users' everyday needs and eliminate shelf product purchases for business solutions that are limited and costly. Users or subscribers may use one or more embodiments of such module to alleviate one or more of the following problems currently faced on a daily basis: frustration of not getting through to the sales people due to busy phone lines; sales people not spending enough time with their customers; waiting for confirmation or approval of an order; lack of knowledge of product availability at a warehouse; accuracy in shipments; getting thru last minute shipment changes the warehouse; awareness of last minute shipments coming too late for purchasing decisions; waiting for reply on standing orders, or on site orders from warehouse through sales people; lack of product updates, sku #s, or available promotions; immediate access to whereabouts of an on-route delivery; a mountain of paperwork in receipts and orders for files; costs associated with sending paperwork to the corporate headquarters; lost receipts, orders, and sign-offs; purchasing costly updates on software; system crashes and lost data; immediate reply on standing orders at warehouse and approval from the sales people; shelf inventory at stores and needs that constantly have to be updated to sales people taking up time; costly IT teams for systems breakdowns; tax time nightmare of organizing receipts, orders, and other paperwork; and training processes for new people are as varied as the personal to place orders.

Another embodiment of the present invention comprises a corporate module. It is contemplated that corporate module is a separate module or part of another module (i.e., a part of the sales person's module for example). In this embodiment, the corporate module comprises at least one of an accounting module and a sales/marketing support and tracking module. The accounting module provides a corporation having multiple warehouses with a variety of accounting options. The corporate module interfaces to the same warehouse accounting systems. The accounting module enables the corporate headquarters to look at each warehouse on a daily, weekly, or monthly schedule. It is contemplated that the number of warehouses or distribution centers being managed by the corporation will not impact the system.

It is also contemplated that the accounting module may provide the corporation with a variety of reporting options (similar to the report generator module as provided previously). Reports may be generated by warehouse, city, state, region, or worldwide for example. These reports may be consolidated at any time. Using the present invention, corporations have the option of designing their own report sets to meet their individual requirements.

The sales/marketing support and tracking module enables corporate support personnel to communicate directly with an individual sales person or to broadcast information regionally or worldwide. This enables corporations/suppliers, etc. to make special pricing, sales promotion information, or special events known immediately.

The sales/marketing support and tracking module enables corporate headquarters to immediately track the effect of an independent action or special promotion. This module provides for direct contact between an end-user, sales person, or warehouse and any other subscriber to the system. This level of communication makes it easy to test market a product, service, or promotion.

Yet another embodiment of the present invention comprises a sales representative merchandising and marketing module communicating with at least the hub of the system. It is contemplated that this module may be a separate module or part of another module. One embodiment of this sales representative merchandizing and marketing module enables the sales people to reach at least one or more customers, to close a deal for example. It is contemplated that this module may comprise at least one of customer incentive packages; direct mail packages; product displays; product tie-in strategies into other industries that service the distribution industry; calendar updates when to promote and move seasonal product with special incentives; merchandising products; marketing promotions and sales incentives; and surveys and objectives of customers and their history.

Still another embodiment of the present invention may comprise a promotions module that is part of, coupled to or communicates with at least the hub of the system. It is contemplated this module may be a separate module or a part of another module (the sales person module for example). In this embodiment, the promotions module is adapted to provide at least advertising strategies and direct mail promotions.

The present invention comprises an end-user business solution module coupled to and communicating with the at least the hub. It is contemplated that such end-user business solution module enables users or subscribers to better communicate with the system, alleviating stress, enhancing time management and providing training for personnel. In one embodiment, the end-user has direct access to their sales person, warehouse/distributor order confirmation, delivery service, and location/delivery time of their order. It is contemplated that, in at least one embodiment, the end-user business solution module may provide for: order entry; route scheduling; data exchange; inventory product power search; customer service; ticket entry and immediate updates.

In one embodiment the End-User Business Solution module may comprise a trucker module or system which is adapted to help truckers in the distribution industry (i.e., the food distribution industry for example) better communicate and serve their customers (i.e., warehouses, sales representatives, and end users) in the order taking process. It is contemplated that such module enables truckers to provide affordable service that is dependable, offer a time management service that is customized to their everyday needs, eliminate shelf product purchases for business solutions that are limited and costly, and grow profits for themselves, which in turn grow profits for their respective warehouses and companies.

It is further contemplated that using at least one embodiment of the trucker module, enables truckers to alleviate one or more of the following problems: rushed order pulling and loading mistakes at the “warehouse rush hour” which may cause timely and costly turnaround trips to fill orders correctly; lost receipts, sign-offs, checks, and cash; not receiving routing changes, orders, and cancellations while on route; inability to reach sales representatives, warehouse, or customers because phones are busy or unavailable; down time while waiting approval from warehouse for on-site order from customers; incorrect or no updates on product SKU #'s and descriptions; product unavailability at warehouse for on-site orders from customers; no dump tracking; and reaching all customer base for last minute shipments.

It is anticipated that the trucker module improves communication for truckers within the delivery process, alleviating stress, and enhancing time management, enabling higher profits. It is contemplated that the trucker module provides one or more of the following: order entry by date, route, and sub-route for regular orders by customers; load requests for standard, regular, and future orders; route scheduling specifying customer delivery days, routes, and route sequence for each day of the week; route settlement comprising printing or displaying route settlement for current day or any day in the past and/or end of day inventory, driver's expenses, commissions, sales, returns, settlements, cash collections, and payments received; data exchange with one or more different modules; inventory produce search by description, category, group, brand, sub-brand, pricing, weight, status, case factor, tax status, warehouse, and sales representative; customer signature screen on screen and file to hold customer's signature sign off without paperwork; customer service providing immediate contacts for online customer problems, customer contact and whereabouts of shipment delivery anywhere, anytime; a library of all customers, sales representatives, and warehouses, retrieval of customers by chain, name, route, address, and phone number, date specific customer sequence by chose input, customer's messages printed directly onto order, customer delivery options, customer specific invoicing to have separated billing types, billing periods, invoice layout, and pricing options, ticket entry including product dumps.

It is also contemplated that this module may enable entering customer product returns not good for resale (ID# by code); product buybacks Customer product returns good for resale, sold Items: Items and quantities sold to customer, on-shelf: Customers on-hand shelf inventory, end invoice: Invoice printout of customer's purchases, dump tracking: Enters all dumped product with a reason (reasons will be identified by code); customer and route surveys including detailed information logged in for sales purposes of what works and what doesn't; invoice printing including delivery, picking, or loading tickets by customer on route and customized customer invoicing with multiple pricing, billing or configuration options; and immediate updates to everyone in the system including end of day reconciliation to warehouses, sales representatives, and customers can all be alerted and sent order information with no delays to the process, requirements for the system's Trucking Business Solution Application, palm pilot or lap-top computer, internet connection, and all SKU #'s from warehouses, companies, or food manufacturers they are responsible for delivering.

Another embodiment of the present invention comprises an End-User Business Solution or module. In one embodiment, this module may comprise an advertising website for the distribution industry. It is contemplated that the advertising website enables users to advertise products and services on an exclusive basis dedicated to a particular distribution industry. This module provides for the advertising of products, specials, or services. More specifically, the website of this particular module may provide a way for those industries that work within the distribution industry to make their products and services known to a target group. The ads may be directed by class (i.e., end-user, sales representative, warehouse, or corporate). Such adds may also be broadcast to all users.

Another embodiment of the present invention comprises an inventory information module may be used by the sales person and their customer. The sales person and customer would be able to see what products are available and will know what to order without the fear of receding late deliveries. If the sales person is affiliated with multiple warehouses, then in at least one embodiment, the system will provide the sales person/end user inventory information from all the warehouses. In one embodiment, the sales person may see the separated inventory listing; however the customer would only see the available products in general. The system would then send the appropriate orders to the warehouse that has the ordered product in stock.

For example, if warehouse 1 provides milk, while warehouse 2 provides bread, the customer may order bread and milk using one embodiment of the present invention. The system would then issue two orders, one for milk to warehouse 1 and one for bread to warehouse 2. Instead of the sales person issuing two separate invoices to the customer, the system would compile the data and issue one invoice based on the sales person's pricing. The sales person has no need to type up invoice because the system would handle all of that. The sales person may print out the invoice for his own personal paper record.

It is contemplated that many warehouses have to generate daily, weekly and monthly, semi-annual and annual reports. Currently, in order to fulfill these reports, the warehouses have to re-enter data into the computer to generate the needed reports. Not only does this require that date be re-entered, but the warehouses generally use make-shift applications from off-the-shelf applications to accomplish this task. Many hours and lost weekends are a result of this current method.

Similar to the other modules provided above, at least one embodiment of the present comprises a report generator module, preferable online. There will be no need for the warehouse to re-enter data. Since reports are generated by existing orders and data from the entire transactions taken place by the other modules, this enables the report generator module to use existing data and to automatically process all the data for the for the warehouse. This saves the warehouse valuable time, and will enabling them to spend-more time with their customer needs and service.

The report generator module provides for data accuracy. Since there is no need to transfer data from paper and re-enter data, the human error element is eliminated or reduced. There is less of a chance of error during the transition. This reduces report errors and helps both warehouse and the corporate office to strategize better customer service methods.

The accounting module will provide for easy updating because all accounting solutions will be linked or interfaced to share critical data. The accounting systems will include but is not limited to: Accounts Receivable; Accounts Payable; Payroll; Taxes (Federal, State, Local); Cost Accounting; Inventory; Budget and sales Forecasting.

One embodiment comprises an instant emergency messaging module. In those instance where an order goes wrong, the warehouse can use this module system to immediately notify the sales person of a problem. In turn the sales person can relay this information to the customer in a timely manner. The system would give an alert, whether it is an email or an online message. Then the sales person can take necessary steps.

One embodiment comprises a corporate accounting module adapted to provide a corporation with multiple warehouses a variety of accounting options. The corporate system will interface to the same warehouse accounting systems. This provides the corporate headquarters with the ability to look at each warehouse on a daily, weekly, or monthly schedule. The number of warehouses or distribution centers being managed by the corporation will not impact the system.

The corporation will also have a variety of reporting options. Reports can be generated by; warehouse, city, state, region, or worldwide. They will then be able to generate consolidated at any time. They will also have the option of designing their own report sets to meet their individual requirements.

One embodiment of the present invention comprises a sales support/marketing module feature providing the ability for corporate support personnel to communicate directly with an individual sales representative or to broadcast information by region or worldwide. This will make special pricing, sales promotion information, or special events know immediately.

Another embodiment of the present invention comprises a tracking module that enables the corporate headquarters to immediately track the effect of an independent action, special promotions, etc. (in real time for example). The system provides for direct contact from anyone from the end-user, sales representative, or warehouse. This level of communication will make it very easy to test market a product, service, or promotion.

It is contemplated that one or more modules may use one or more communication devices to communicate with the system (the hub for example). For example, in the sales person module, the communication device may comprise at least one computer or laptop, at least one internet connection and an Internet Browser. To support at least the wireless module, the communication device may comprise a laptop with wireless networking card with a wireless account or handheld device that supports wireless service. The customers may use one or more phone, faxes, and/or computers with internet access (i.e., ethernet; Gigabit Ethernet, etc) to communicate with the system. In the warehouse module, the communication device may comprise one or more computer terminals, one or more servers and a connection (a T-1 connection or equivalent) communicating with the system. In the corporate module, the communication device may comprise one or more computer terminals, one or more servers, and a connection (a T-1 Connection or equivalent:; for the end users, the communication device may comprise a computer terminal (including a laptop) and an internet connection; and the r trucker module, the communication device may comprise a computer terminal, laptop or handheld device and a wireless internet connection.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An on-line communication system adapted to be used in a delivery industry comprising:
at least one of a sales person module;
at least one of a warehouse module and a delivery module; and
at least one end-user module adapted to communicate with at least one of said sales module, warehouse module and delivery module.

2. The system of claim 1, wherein at least one of said sales person module and said end-user module communicating with a plurality of warehouse.

3. The system of claim 1, wherein said sales module comprises at least one of an online ordering module, a bookkeeping module, a sales representative and marketing module, a report generator module, a promotions module, a customer and route surveys module and a warehouse module.

4. The system of claim 1, wherein said online order module comprises a website for each sales person.

5. The system of claim 1, wherein said warehouse module comprises at least one of an order tracking information module, an inventory information module, a report generator module, an accounting module and an instant emergency messaging module.

6. The system of claim 1, wherein said delivery module comprises at least one of an order entry module, a load request module, a route scheduling module, a data exchange module, an inventory produce search module, a customer service module, a ticket entry module, a customer and route survey module, an invoice printing module and an immediate update module.

7. The system of claim 1 wherein said end user module comprises at least one of an order entry module, a route scheduling module, a data exchange module, an inventory product power search module, a customer service module, a ticket entry module and an immediate up-date module.

8. The system of claim 3 wherein said sales representative and marketing module.

9. The system of claim 1 further comprising a wireless module adapted to enable at least one sales person to communicate with at least one of said sales module, said warehouse module, said delivery module and said end-user module in a wireless manner.

10. The system of claim 1 further comprising a corporate module communicating with at least one of said sales module, said warehouse module, said delivery module and said end-user module.

11. The system of claim 10 wherein said corporate module comprises at least one of an accounting and report module and a sales/marketing support and tracking module.

12. The system of claim 1 further comprising a hub communicating with at least one of said sales module, said warehouse module, said delivery module and said end user module.

13. The system of claim 1 comprising a report generator module communicating with at least one of said sales module, said warehouse module, said delivery module and said end-user module.

14. An on-line communication system adapted to be used in a distribution industry comprising:
a hub;
a sales person module; and
at least one of a warehouse module, a delivery module and a corporate module communicating with at least said hub; and
at least one end-user module adapted to communicating with said hub and at least one of said sales module, warehouse module, delivery module and corporate module.

15. The system of claim 14 further comprising a wireless module adapted to enable at least one sales person to communicate with at least one of said sales module, warehouse module, delivery module, corporate module and end-user module in a wireless manner.

16. An ordering method used in a distribution industry comprising:
communicating with at least one sales person responsible for at least two distribution warehouses using a communication system; and
communicating an order confirmation to said sales person using said communicating system.

17. The method of claim 16 wherein said communication system is an web-based ordering system.

18. The method of claim 16 wherein said communication system comprises at least one end-user module and at least one of a sales module, a warehouse module and a delivery module adapted to communicate with at least said end-user.

19. The method of claim 16 further comprising communicating said confirmation order to an end user.

20. The method of claim 26 further comprising communicating said confirmation order to an end user.

21. The method of claim 16 further comprising providing at least one of an accounting service, a bookkeeping service, and a report generating service.

22. An ordering method used in a distribution industry comprising:
placing at least one order using a communication system;
communicating an order confirmation using said communicating system; and
generating at least one sales order using said communication system.

23. An on-line ordering service comprising:
providing on-line ordering;
providing confirmation of said on-line ordering; and
providing at least one of bookkeeping and report generating with respect to at least said on-line ordering.
